(19) United States
(12) Patent Application Publication
(10) Pub. No.: US 2005/0270563 A1
(43) Pub. Date: Dec. 8, 2005

(54) Image forming apparatus and display controlling method thereof

(75) Inventors: Yoshihisa Kamata, Hadano-shi (JP); Takao Kurohata, Tokyo (JP); Hironobu Hirayama, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/052,852

(22) Filed: Feb. 9, 2005

(30) Foreign Application Priority Data
Jun. 2, 2004 (JP) JP2004-164827

(51) Int. Cl. G06F 15/00

(52) U.S. Cl. 358/1.15

(57) ABSTRACT

Disclosed in one embodiment is an image forming apparatus 100 that obtains information about paper sheets on trays from an image control CPU 85, compares the obtained information to paper information entered at an operation section 48 and controls an LCD 18 not to display the quantities of left-over paper when the entered paper information is not equal to the information of paper sheets on trays.

### BACKGROUND OF THE INVENTION

1. Field of the Invention

This invention relates to an image forming apparatus and display controlling method thereof which can reserve a job while executing another reserved job and optionally display the quantities of paper sheets in trays.

2. Description of Related Art

Conventional image forming apparatuses detect quantities of paper sheets set in paper trays and display this kind of information on their operation panels.

To do so, for instance, the image forming apparatus measures a time period during which a tray (bottom plate) moves up from the start position to the stop position in the paper cassette, converts this time value into the quantity of paper sheets left on the tray, and displays it on a display unit. One such apparatus is disclosed in Japanese Non-examined Patent Publication No. 2001-48380 (hereafter, Patent Document 1).

Apart from the above mentioned conventional technique, other conventional image forming apparatuses can simultaneously reserve a second job while executing a first job.

To do so, the image forming apparatus is equipped with an input component by which the user provides instructions to the image forming apparatus and a controller that receives a second instruction from the input component and can (1) accept the second instruction while the image reading section reads an image in response to a first instruction and can start image reading in accordance with the second instruction while the image output section outputs an image based on the first instruction. One such apparatus is disclosed in Japanese Non-examined Patent Publication H08-55228 (hereafter, Patent Document 2).

In this way, the user can input settings for the second job without restrictions while executing the first job. Further to this, the first and second jobs can be executed simultaneously. Therefore, the user can initiate the second job before the first job is finished; this finally saves time. In this case, the user can set the function of the second job without being limited by the function of the first job. Further, the user can register and start the preset second job easily without any complicated operations. Further, when the first job ends, the second job automatically becomes the first job and the user can set another job before the second (now first) job ends. Therefore, two or more jobs can be processed efficiently. Further, the preset number of copies for the second job are displayed in an area separate from the display area for the first job so that the user can recognize the preset number of copies and the number of copies that are already made for the first job and easily know the running status of the first job even while setting or executing the second job.

However, the image forming apparatus of Patent Document 1 does no relate to an apparatus having a reservation function for the future jobs while a current job is being executed, and usually allows a user to select a paper size only from sizes that are loaded on the paper trays in the apparatus. If a necessary paper size is not loaded on the paper tray, the image forming apparatus cannot accept the such an input and the user must wait until the user places sheets of the reserved paper size on another paper tray or until the current job ends.

Further, the image forming apparatus of Patent Document 2 enables the user to set a next job (the second job) without restrictions by the current job (the first job) and begin execution of the next job during execution of a current job. However, if a size or type of paper needed for the next job is not loaded on the paper tray during the first job, the image forming apparatus has to stop because it cannot recognize the needed paper on the paper tray when the current job is executed.

### SUMMARY

Accordingly, an object of this invention is to provide an image forming apparatus and its display control method that is convenient for a user who wants to initiate settings for a reserved job during the execution of image forming operation based on a current job.

Another object of the present invention is to provide an image forming apparatus and its display control method that can recognize that the reserved paper sheets are not on the paper tray and prevent the user from misunderstanding the paper information on the screen of the display.

To achieve at least one of the above mentioned object or another object, the image forming apparatus consistent with an embodiment of this invention consists of an image reading section for reading images, a counter for detecting the quantity of paper in each paper tray, a display for displaying the paper quantity detected by the counter, and an image forming section for forming images on paper sheets supplied from the tray and ejecting them, wherein the image forming apparatus further comprises: a paper manager for obtaining information about recording paper set in each tray; a reservation handler for reserving image formation jobs; a scheduler for comparing information obtained by the paper manager with paper information set by the reservation handler; and a controller for controlling the display to display the results of the comparison when the paper information set by the reservation handler is different from information of paper set in paper trays.

The information about paper sheets loaded on trays may be paper sizes, types, weights, colors, or punching.

In another example, the controller may control the display not to display the quantity of paper sheets when the information of paper sheets entered by the reservation manager is not equal to the information of papers sheets on paper trays.

In yet another example, the scheduler compares the paper information of only a tray that is selected by the reservation manager with the paper information entered by the reservation manager and the controller controls the display not to display the quantity of left-over paper when the paper information set by the reservation manager is different from the information of paper sheets set in the selected paper tray.

The display controlling method of this invention is for an image forming apparatus comprising an imager reader for reading images, a counter for detecting the quantity of paper in each paper tray, a display for displaying the paper quantity detected by the counter, and a printer for forming images on paper sheets supplied from the tray and ejecting them, wherein the method comprises: obtaining information of paper sheets set in trays; reserving an image reservation job; comparing the information of paper sheets set in trays with information of paper sheets entered in the image reservation job; and displaying the difference of information when the paper information entered in the image reservation job is not equal to the information of paper sheets set in trays.

For example, the quantity of left-over paper may not be displayed when the paper information in the image reservation job is different from the information of paper sheets set in paper trays.

In another example, the scheduler may compare the paper information of only a tray that is selected in the image reservation job with the paper information entered in the image reservation job, and the quantity of left-over paper may not be displayed when the paper information in the image reservation job is different from information of paper sheets set in the selected paper tray.

The objects, characteristics and properties of this invention other than those set forth above will become apparent from the description given herein below with reference to preferred embodiments illustrated in the accompanying drawings.

### BRIEF DESCRIPTION OF THE DRAWINGS

FIG. 1 shows a vertical sectional view of an image forming apparatus 100 consistent with an embodiment of this invention.

FIG. 2 is a functional block diagram of a control circuit of the image forming apparatus 100 as an example.

FIG. 3 shows a display example of a copy screen consistent with an embodiment of the present invention.

FIG. 4 shows a display example of a copy reservation screen consistent with an embodiment of the present invention.

FIG. 5 shows a display example of a size setting screen consistent with an embodiment of the present invention.

FIG. 6 shows a display example of a type selection screen consistent with an embodiment of the present invention.

FIG. 7 shows a display example of a type change/setting screen consistent with an embodiment of the present invention.

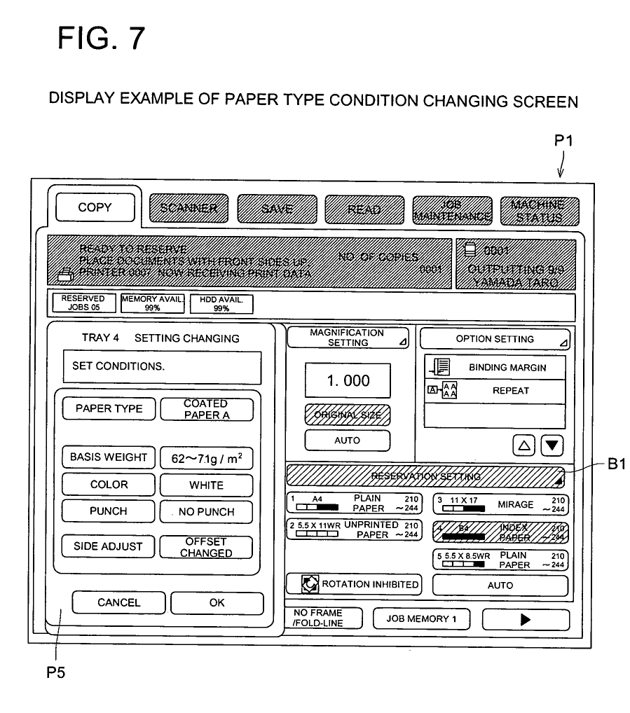

FIG. 8 shows a display example of the copy screen on which quantities of left-over paper are not displayed consistent with an embodiment of the present invention.

FIG. 9 shows a flow chart of operation of the image forming apparatus 100 consistent with an embodiment of the present invention.

### DETAILED DESCRIPTION

Below will be explained exemplary embodiments of an image forming apparatus and display controlling method thereof in accordance with this invention with reference to the accompanying drawings.

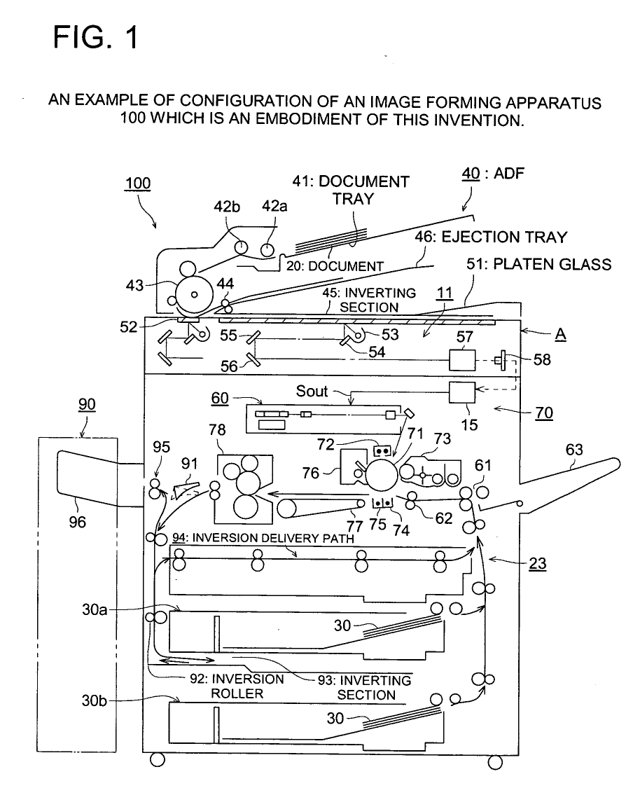

FIG. 1 shows a vertical sectional view of an image forming apparatus 100 consistent with an embodiment of this invention.

The image forming apparatus 100 of FIG. 1 forms images according to preset information and may be applied to copying machines, printers, and multifunction peripheral (MFP) having the functions of copying, printing and so on that form images on recording paper sheets by executing registered jobs in a preset order. In this example, the image forming apparatus 100 is a monochromatic direct-transfer type MFP. The machine body A can be connected to a post-processing device 90. The machine body A contains paper trays (30a and 30b), an image reading section 11, a controller 15, an write control section 60, an image forming section 70, and so on.

The machine body A has an automatic document feeder (ADF) 40 on the top of the body to automatically feed documents 20. For example, the ADF 40 may consist of a document tray 41, rollers (42a, 42b, and 43), delivery rollers 44, and an ejection tray 46. The document tray 41 places one or more documents 20 on it. Rollers 42a and 42b are provided in the downstream side of the document tray section 41. When the Automatic Document Feed mode is selected, a document 20 is fed from the document tray section 41, delivered by, and U-turned by the roller 43 in the downstream side. In the Automatic Document Feed mode, documents 20 are placed on the document tray section 41 with their recording sides facing upward.

The image reading section 11 is provided in the machine body. The image reading section 11 may constitute a reduction type image sensing system. For example, when a document 20 is U-turned by the roller 43, the image reading section 11 reads the surface of the document 20 and outputs its image data (hereinafter termed document image data Din).

The image reading section 11 may be equipped with a first platen glass 51, a second platen glass 52 (or an ADF glass), a light source 53, mirrors 54, 55, and 56, an imaging optic section 57, a CCD image pick-up device 58 and an optical system driving section which is not shown in the drawing. After it is read by the image reading section 11, the document 20 is delivered to the ejection tray 46 by the rollers 44.

The image reading section 11 is equipped with a CCD image pick-up device 58 which constitutes the reduction type image sensor. The controller 15 is connected to the output stage of the CCD image pick-up device 58. After processing the document image data Din, the controller 15 outputs the processed data Sout to the write control section 60. The write control section 60 may comprises a laser scanning optical system, so that a laser diode is driven to output modulated laser light in accordance with the processed data Din, and the modulated laser light is scanned and exposed to the image forming section 70.

The image forming section 70 forms an image on a recording sheet 30 fed from the paper tray 30a or 30b. The image forming section 70 consists of an organic photosensitive drum (simply abbreviated as a photosensitive drum below) 71, a charger 72, a developer 73, a transfer unit 74, a separator 75, a cleaning section 76, a delivery mechanism 77, and a fixing device 78.

The charger 72 is provided above the photosensitive drum 71 to charge the surface of the photosensitive drum 71 evenly at a prescribed potential. Then, the photosensitive drum is exposed by the modulated laser light from the write control section 60 to form an electrostatic latent image on the surface of the photosensitive drum 71. The write control section 60 is provided, for example, to the oblique upper right side of the photosensitive drum 71.

In one embodiment, the developer 73 containing toner and carrier (as a developing agent) is provided to the right of the photosensitive drum 71. The latent image formed on the photosensitive drum 71 by the write control section 60 is made visible with this toner. Below the developer 73 are provided resist rollers 62 and paper feed trays (30a and 30b). A manual paper feeding tray 63 is provided on the right of the machine body A. Recording sheets are delivered from the paper tray (30a or 30b) or the manual paper feeding tray 63 to a space under the photosensitive drum 71 by the delivery roller 61 and the resist roller 62 under paper feed control.

Each paper tray (30a and 30b) has a tray lifting motor and a tray upper-limit sensor (not shown in the drawing). The quantity of paper sheets in the paper tray can be determined using information from the tray lifting motor and the tray upper-limit sensor.

The transfer unit 74 is provided below the photosensitive drum 71 and transfers the toner image, which was formed on the photosensitive drum 71 by charging, exposing, and developing, to a recording sheet 30 whose delivery timing is controlled by the registration rollers 62. The separator 75 is provided near the transfer unit 74 to separate the image-transferred sheet 30 from the photosensitive drum 71. In the downstream side of this separator 75 is provided a delivery mechanism 77. The fixing device 78 is provided at the end of the delivery mechanism 77. The fixing device 78 fixes the toner image firmly onto the sheet 30. A cleaning section 76 is provided opposite the photosensitive drum 71 between the delivery mechanism 77 and the charger 72 to remove left-over toner from the photosensitive drum 71.

When the Double-Sided Copy mode is selected in this example, one image is formed on one side (or the front side) of the sheet and another image is formed on the other side (the back side) of the sheet after the sheet is ejected from the fixing device 78. The paper sheet 30 coming from the fixing device 78 is branched from the paper ejection path by the branching means 91, turned upside down by the inversion rollers 92 and the inverting section 93 which constitute the paper feeding section 23. The inverted sheet 30 goes through the inversion delivery path 94 and enters the normal paper feed path before the paper feed rollers 61.

The paper is further delivered to the transfer unit 74 through the registration rollers 62 and receives a toner image on the other side (back side) of the sheet 30. Then the sheet 30 having a toner image on the back side is fixed by the fixing device 78, clamped by the ejection rollers 95, and ejected to the paper ejection tray 96 or the like outside the apparatus. The output destination of the processed sheet is not limited to the tray 96. In some cases, the processed sheet is bound or stapled by, for example, post-processing unit 90.

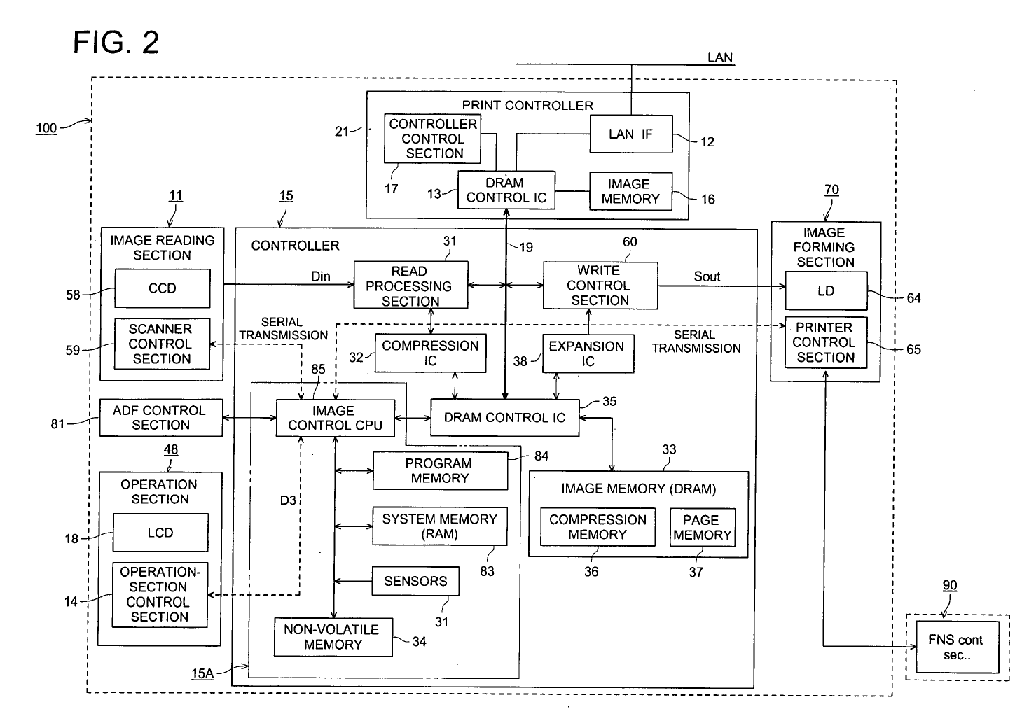

FIG. 2 is a functional block diagram of a control circuit of the image forming apparatus 100 as an example. As shown in FIG. 2, the image forming apparatus 100 consists of a image reading section 11, a controller 15, a print controller 21, an operation section 48, an image forming section 70, an FNS controller 80 and an ADF controller 81.

In FIG. 2, the image reading section 11 (e.g., a scanner) is connected to the controller 15. After image processing, the controller 15 outputs the document image data Din to the image forming section 70.

The print controller 21 consists of LAN interface 12, a DRAM control IC 13, image memory 16, and a controller control section 17. The print controller 21 is connected to the controller 15 through a PCI bus 19.

The LAN interface 12 is used to implement communication between the image forming apparatus 100 and an external information processing apparatus such as a computer, for example, when the image forming apparatus 100 is used as a printer or when a program, such as a firmware, is rewritten or updated.

In one embodiment, the DRAM control IC 13 is connected to the LAN interface 12. The image memory 16 and the controller control section 17 are connected to the DRAM control IC 13. In the Print mode, the image forming apparatus receives print data and other data from the outside computer or the like and stores it under control of the controller control section 17 and the DRAM control IC 13.

The controller 15 reads print data from the image memory 16 and performs image processing on the data. To the controller 15 are connected the image reading section 11, the print controller 21, the image forming section 70, the operation section 48, and the ADF controller 81.

The image reading section 11 contains a scanner controller 59 in addition to the CCD image pick-up device 58 of FIG. 1. The scanner controller 59 controls inputs and outputs for the CCD image pick-up device 58. For example, when the Automatic Document Feed mode is selected, the scanner controller 59 performs so that a document 20 from the document tray 41 may be U-turned by the rollers 43 in the downstream side. While the document 20 is U-turned by the rollers 43, the CCD image pick-up device 58 reads image information from the surface of the document. The analog image signal from the CCD image pick-up device 58 is converted into digital image data Din.

In the embodiment of FIG. 2, the controller 15 consists of a read processing section 31, a compression IC 32, image memory (DRAM) 33, non-volatile memory 34, a DRAM control IC 35, an expansion IC 38, and a write controller 60. Document image data Din is output to the read processing section 31, which is connected to the image reading section 11 and the PCI bus 19, and read by the read processing section 31. Further, the read processing section 31 is connected to the compression IC 32. The document image data Din is compressed and encoded by the compression IC 32 to create compressed image data.

The compression IC 32 is connected through the DRAM control IC 35 to the image memory 33 which is DRAM having compression memory 36 and page memory 37. The compression memory 36 stores compressed image data under memory control of the DRAM control IC 35. The expansion IC 38, connected to the DRAM control IC 35, expands and decodes the compressed document image data in image formation. The expanded and decoded image data is used as document image data Din. The image data Din is stored in the page memory 37. The DRAM control IC 35 also may detect the end of a job.

The write controller 60 is connected to the PCI bus 19 and reads the document image data Din and generates a laser driving signal Sout. The write controller 60 outputs the laser driving signal Sout to the image forming section 70. In one embodiment, it is possible to connect the expansion IC 38 directly to the write controller 60 and send the expanded and decoded document image data Din directly to the write controller 60 without passing it through the page memory 37.

The controller 15 of FIG. 2 is connected to the operation section 48 which may include a keypad used to set image formation conditions such as the number of copies, image contrast, etc. and to select a paper tray, e.g., paper tray 30a or 30b. The operation section 48 may also be used to reserve image formation jobs such as a copying job.

The operation section 48 is equipped with an operation panel (not shown in the drawing) and a liquid crystal display (LCD) 18 which displays image forming conditions such as paper sizes, numbers of copies, and image contrasts. The LCD 18 may also display quantities of paper on paper trays. The operation section 48 may have a touch-sensitive panel on the LCD 18 to provide a keypad or graphic user interface (GUI). In addition to the LCD 18, the operation section 48 is also equipped with an operation-section controller 14. This controller 14 controls LCD 18 and receives touch-detection signals generated on the touch-sensitive panel. Input signals from the touch-sensitive panel are sent to the image control CPU 85 in the controller 15A. The operation data D3 entered from the operation section 48 is stored in system memory 83.

The image forming section 70 of FIG. 2 is equipped with a laser diode (LD) 64 and a printer controller 65 that works to form images according to the settings made using the operation section 48.

The laser diode (LD) 64 generates a laser light according to the laser driving signal Sout. The scanning mechanism in the write controller 60 applies this laser light to the photosensitive drum to scan and form a latent image on the surface of the photosensitive drum. The latent image is developed with toner by the image forming section 70 and transferred to a selected paper sheet 30. The printer controller 65 outputs the processed document image data or print data to the image forming section 70 and controls image formation.

The FNS controller 80 is connected to the printer controller 65 to control the post-processing unit 90 which post-processes the fixed paper sheets 30.

The controller 15A contains non-volatile memory 34, system memory (RAM) 83, program memory 84, and the image control CPU 85. The image control CPU 85 is connected to the DRAM control IC 35.

In one embodiment, the image control CPU 85 controls the image forming apparatus using a program stored in the program memory 84.

The controller 15A may perform as a paper manager when it obtains information on paper sheets set on the trays. For example, the controller 15A may obtain size information of paper set on each tray from the paper size detection sensors 31 and information on paper type and so on from system memory 83.

Controller 15A may also compare paper information reserved by a user with the obtained information about paper on the trays. If these pieces of information are different from each other, the controller 15A may direct the LCD 18 not to display the quantity of paper left on trays by the paper indicators.

Non-volatile memory 34 and program memory 84 connected to the image control CPU 85 may be rewritable memory and may retain their content when not powered.

The ADF controller 81 controls the operation of the ADF 40 to perform automatic document feeding.

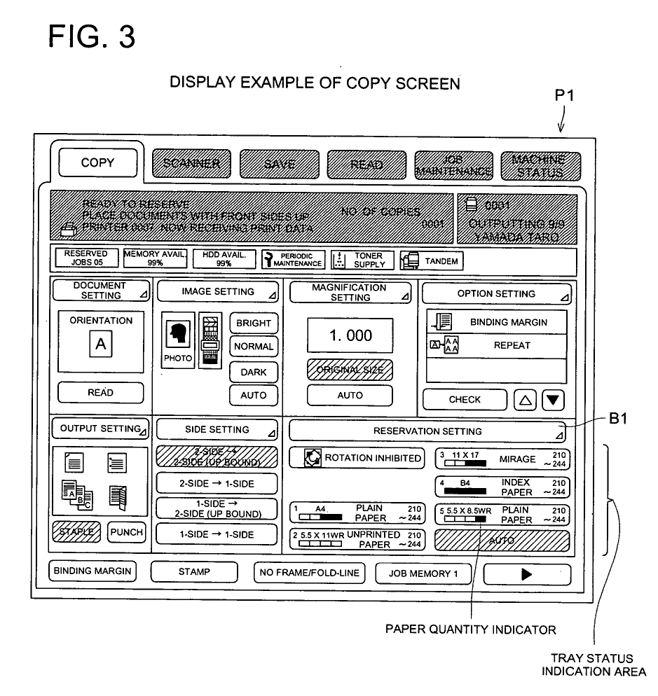

FIG. 3 shows a display example of a copy screen on the operation section consistent with an embodiment of the present invention. As shown in FIG. 3, the copy screen P1 contains various operation buttons such as “Document setting,” “Image setting,” “Magnification setting,” “Option setting,” “Output setting,” “Side setting,” “Reservation setting” and so on. A paper tray status indication area is provided under the “Reservation setting” button B1. The paper tray status indication area displays paper tray status information such as paper size, type, and quantity of paper on each tray.

As shown in FIG. 3, in one embodiment the tray status indication area has an indication bar made up of four mini-bars to indicate five paper quantity levels. The mini-bars blink or light to indicate the quantity of paper left on each tray: One mini-bar blinks to indicate Level 1 (10% paper left); One mini-bar lights to indicate Level 2 (25% paper left); Two mini-bars light to indicate Level 3 (50% paper left); Three mini-bars light to indicate Level 4 (75% paper left); and Four mini-bars light to indicate Level 5 (100% paper left).

The quantity of paper left in each tray may be detected using a method similar to that disclosed in Patent Document 1. That is to say, the quantity can be detected by measuring a time period during which a tray (bottom plate) moves up from the start position to the stop position in the paper cassette, and converting this time value into the quantity of paper sheets left on the tray). For each paper tray, this measured paper quantity of a paper tray is an initial quantity after a user loaded papers to the paper tray. The current paper quantity can be calculated by subtracting from the initial quantity the number of papers of the corresponding paper tray that were used after the loading of the papers.

The user may input paper information for a reserved job (a future job) for each paper tray (e.g., sizes, types, basis weights, colors, punching of paper, and/or side adjustment) by pressing the “Reservation setting” button B1 on the Copy screen P1.

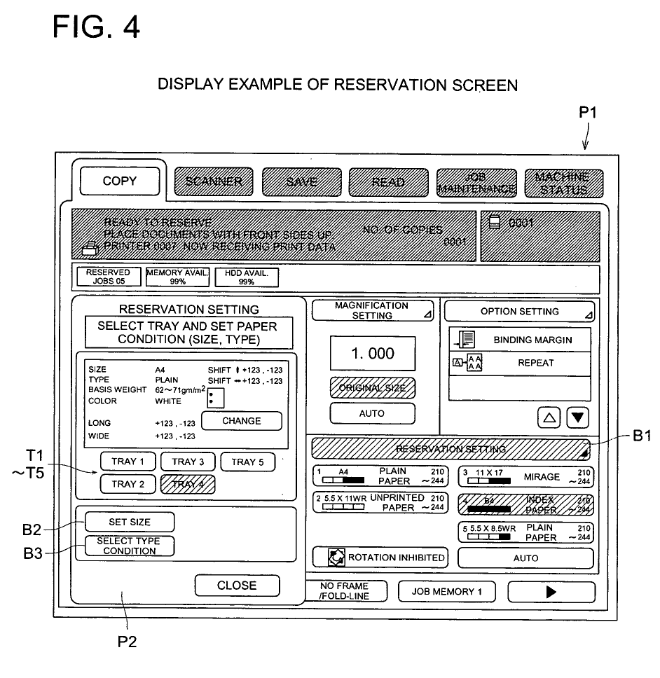

FIG. 4 shows a display example of a copy reservation screen consistent with an embodiment of the present invention. As shown in FIG. 4, when the “Reservation setting” button B1 on the copy screen P1 has been pressed, the “Reservation setting” pop-up screen P2 appears to enable the user to input information for a reserved job. This screen P2 contains tray selection buttons “Tray 1” T1, “Tray 2” T2, . . . , “Tray 5” T5, a size selection button B2, and a type selection button B3. After selecting a tray by pressing its selection button (T1 to T5), the user can set a paper size or select a paper size condition. For example, after pressing the button T4 to select tray 4, the user may press the Size Set button B2 and sets a paper size for a reserved job using tray 4.

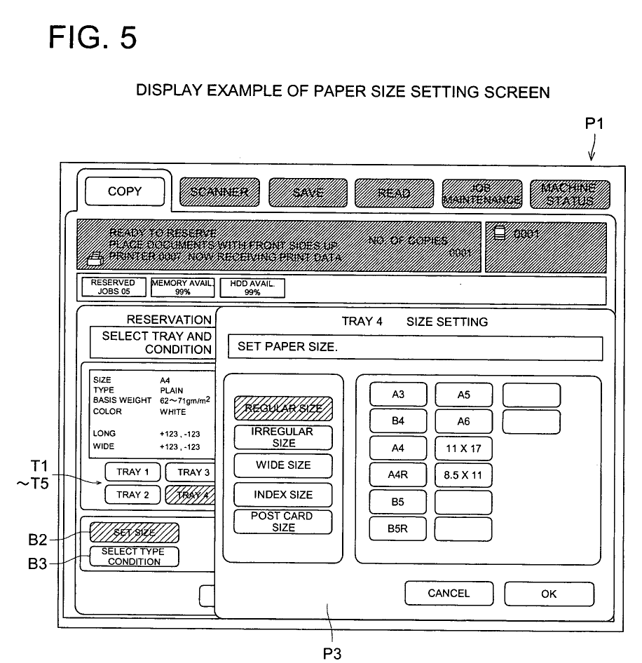

FIG. 5 shows a display example of a size setting screen, consistent with an embodiment of the present invention. As shown in FIG. 5, when the Size Set button B2 has been pressed, the “Tray 4 Size Setting” pop-up screen P3 appears. This screen P3 contains options such as “Regular,” “Irregular,” “A3,” “A4,” “B5,” etc. buttons for selection. By selecting and pressing these buttons, the user can set the selected size of paper for the reserved job.

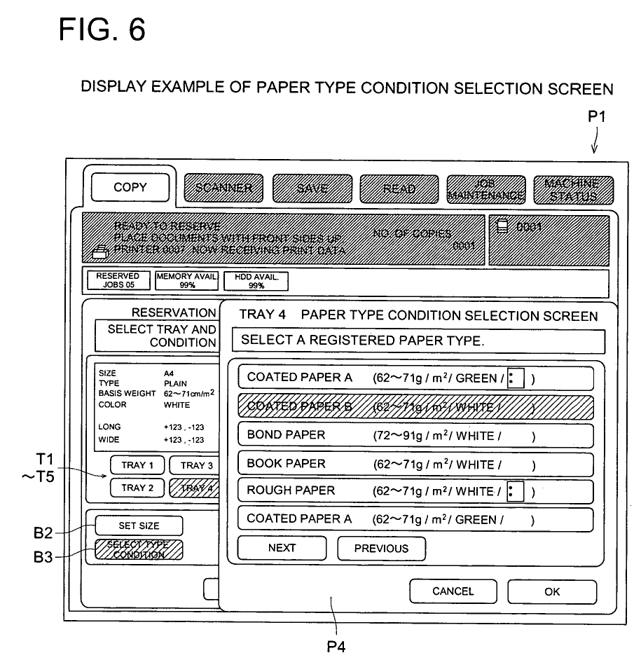

FIG. 6 shows a display example of a type setting screen consistent with an embodiment of the present invention. As shown in FIG. 6, when the Select Type Condition button B3 has been pressed, the “Tray 4 Type Condition Selection” pop-up screen P4 appears. This pop-up screen P4 contains options such as “Coated paper A,” “Coated paper B,” “Bond paper,” and so on. Upon a selection of one of these options, Tray 4 “Setting Change” pop-up screen P5 appears to change settings of the selected paper type. On this pop-up screen P5, the user can set a paper type, basis weight, color, punching, and side adjustment for a reserved job. After setting or changing a paper type condition, the user presses the OK button. The paper condition is thus set.

As explained above, after the user inputs options such as paper size or paper type for a reserved job, the controller compares the entered paper information with information about paper currently set on the paper trays. The controller may control the display not to display the quantities of left-over paper on the copy screen (e.g., using the mini-bars) when the paper information input for a reserved job is not equal to the information of paper currently set on the trays.

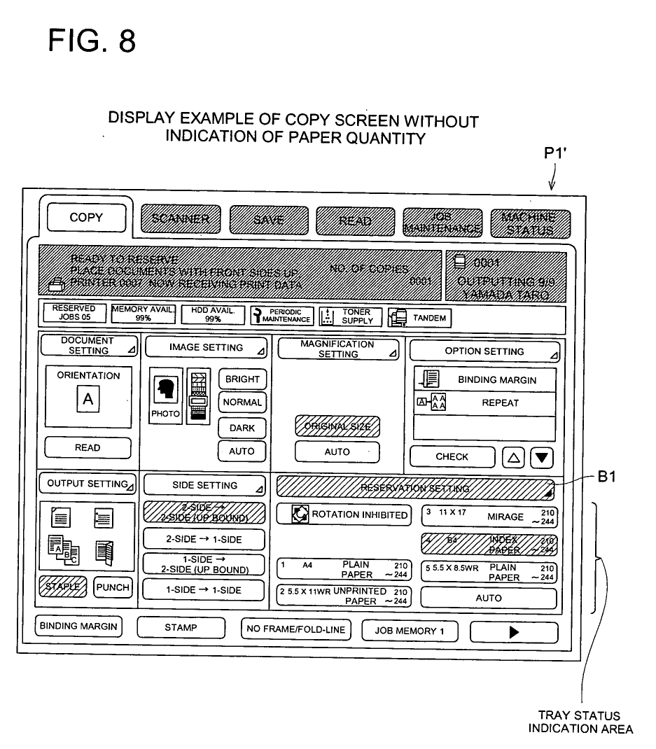

FIG. 8 shows a display example of the copy screen when the entered paper information input for a reserved job is not equal to the information of paper currently set on the trays. As shown in FIG. 8, the tray status indication area under the “Reservation setting” button B1 does not show any quantity of paper on each paper tray. In one embodiment, this means that the paper information set by the user is different from the information of paper in the trays. This may also indicate that the user-selected paper is not found in any tray. In this case, the user would set the correct type of paper on the selected tray after the current job is completed. With this, the next reserved job can be executed and images can be formed.

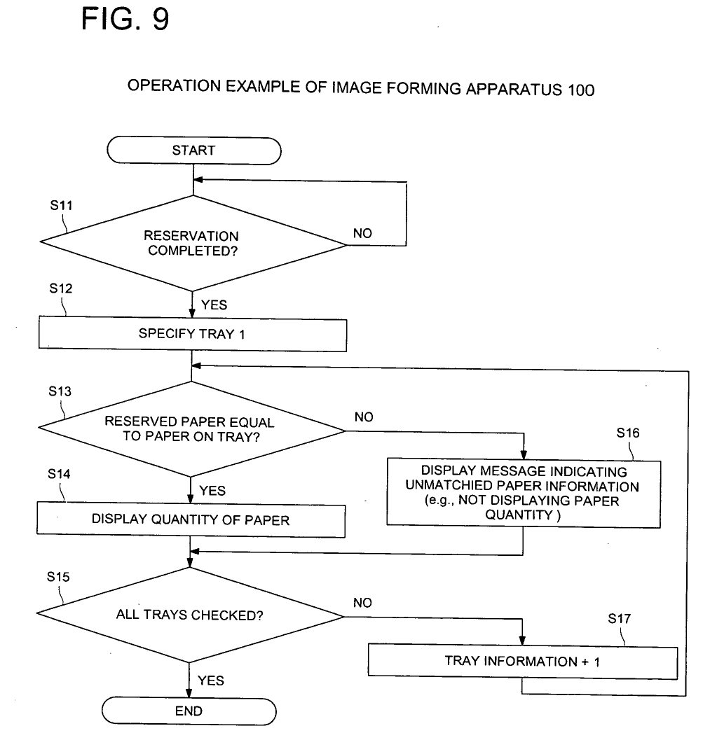

Next will be explained a display control method consistent with an embodiment of this invention using image forming apparatus 100. FIG. 9 shows a flow chart of operation of the image forming apparatus 100 consistent with this embodiment.

In this embodiment, when the user inputs information for a reserved image formation job for the image forming apparatus 100, the controller compares the reserved paper information with the information of paper set on the trays and controls the display not to show the quantities of remaining paper when the reserved paper information is different from the information of paper on the trays.

First, the image control CPU 85 checks whether an image formation reservation is completed (step S11). When the reservation is completed (step S11: YES), the image control CPU 85 specifies tray 1 to compare the reserved paper information with the information of paper on the tray (step S12). Then, the image control CPU 85 checks whether the reserved paper information is equal to the information of paper set on the tray that is currently checked (S13). If these match (step 13:Yes), the image control CPU 85 controls the display to display on the copy screen the quantity of paper on the currently checked tray (step S14). If the information does not match, the image control CPU 85 controls the display not to display the quantity of paper on the currently checked tray on the copy screen (S16).

Next, the image control CPU 85 determines whether all trays are checked (step S15). When all trays have been checked (step S15: YES), the image control CPU 85 terminates the operation. If there is any tray that has not been checked (step S15: NO), the image control CPU 85 increases the tray number by one (e.g. tray 2) (step S17) and repeats the above operation by returning the process to step S13. When all trays have been checked, the image control CPU 85 terminates the operation (S17).

As a result of the process mentioned above, in a case where neither of the trays accommodates the paper appropriate for the reserved job, paper quantities are not displayed at any paper trays on the copy screen as shown in FIG. 8. On the other hand, in a case where one or more trays contains the appropriate paper for the reserved job, the paper quantities of the paper in the matched tray are displayed, while no paper quantities of the paper in the unmatched trays are displayed.

Although the above description assumes that the controller controls the display not to display the quantity of paper on every tray when the reserved paper information is not equal to the information of paper on trays, this invention is not limited to this. For example, it is possible to compare the reserved paper information with information of paper on a selected tray (e.g. tray 4) only and to control the display means not to display the quantity of paper on tray 4. Alternatively, other ways of notifying the user may be used if the reserved paper information does not match the information of paper on the paper trays.

In summary, in an embodiment of this invention, the image control CPU 85 obtains information about paper sheets loaded on paper trays and compares it to paper information entered by a user at the operation section 48 when the user makes a job reservation (e.g. copy reservation) If the input information is different from the information about paper sheets currently loaded, controller 15A controls the LCD 18 not to display the quantities of paper.

Accordingly when the reserved paper sheets are not equal to the paper sheets on the tray in a job reservation, one embodiment of this invention can give correct information and prevent the user from misunderstanding the paper information shown on the display.

In the above example, the quantities of paper on trays are not displayed when the reserved paper information does not match with the information of paper set on trays. This invention is not limited to this. For example, it is possible to display a message indicating that the reserved paper information does not match with the information of paper set on trays (for example, “Paper not available” or “Paper not on tray”) on the tray status display areas.

The foregoing has described principles, preferred embodiments and modes of operation of the invention. However, the invention should not be construed as being limited to the particular embodiments discussed. Thus, the above-described embodiments should be regarded as illustrative rather than restrictive, and it should be appreciated that variations may be made in those embodiments by workers skilled in the art without departing from the scope of the invention as defined by the following claims and equivalents thereof.

1. An image forming apparatus that reproduces images using paper stored in trays, wherein said image forming apparatus further comprises
a paper manager that obtains information about paper in at least one paper tray during a current job,
a reservation handler for receiving data for a reserved image formation job,
a scheduler for comparing the information obtained by said paper manager with paper information included in the data received by said reservation handler, and
a controller for controlling display of a result of the comparison when the paper information included in the data received by said reservation handler is different from the information obtained by said paper.

2. The image forming apparatus of claim 1, wherein said paper information includes at least one of a size, paper type, basis weight, color, and punching of paper.

3. The image forming apparatus of claim 1, wherein said controller controls a display not to display the quantity of paper in the at least one paper tray when the paper information included in the data received by said reservation handler is different from information obtained by said paper manager.

4. The image forming apparatus of claim 1, wherein
said scheduler compares the paper information of only a tray selected in the data received by said reservation handler, and
said controller controls said display not to display the quantity of paper sheets in the selected tray when the paper information included in the data received by said reservation handler is different from information obtained by said paper manager for the selected tray.

5. The image forming apparatus of claim 1, wherein
the reserved job is to be performed after the current job.

6. A display controlling method for an image forming apparatus that reproduces images using paper stored in trays, wherein said method comprises
obtaining information of paper sheets set in at least one paper tray,
receiving data for an image reservation job,
comparing the obtained information of paper sheets set in the at least one paper tray with paper information from the data received for the image reservation job, and
displaying a difference indicator when the paper information from the data received for the image reservation job is not equal to the obtained information of paper sheets set in the at least one paper tray.

7. The display controlling method of claim 6, wherein the difference indicator is displayed by not displaying a quantity of left-over paper in the at least one paper tray

8. The display controlling method of claim 6, the comparing further comprises
comparing the obtained information of paper sheets for only a tray that is selected in the data received for the image reservation job, and the displaying further comprises
controlling a display not to display a quantity of left-over paper when the paper information from the data received for the image reservation job is different from the obtained information of paper sheets set in the selected paper tray.

9. The display controlling method of claim 6, wherein
the image reservation job is to be performed after a current job using the paper sheets set in the at least one paper tray.

10. An image forming system for reproducing images onto recording media, the image forming system comprising:
a current job manager that obtains information about a current recording medium being used in a current job executed by the image forming system;
a reservation handler that receives information about a reserved recording medium to be used in a reserved job to be executed by the image forming system separately from the current job; and
a display controller for directing a display to present an indicator when the information about the current recording medium is different from the information about the reserved recording medium.

11. The image forming system of claim 10, wherein the recording media include at least one of: paper, film, tape, and electronic media.

12. The image forming system of claim 10, wherein the indicator is presented by hiding a quantity of recording media available to the image forming system.

13. The image forming system of claim 10, wherein the reserved job is to be executed after the current job.

14. The image forming system of claim 10, wherein said information about a reserved recording medium includes at least one of a paper size, paper type, paper weight, paper color, punching of paper, and electronic medium type.

15. The image forming system of claim 10, further comprising:
an image forming apparatus that forms reproduced images onto the recording medium and displays the indicator.
